(19) United States
(12) Patent Application Publication
(10) Pub. No.: US 2026/0105392 A1
(43) Pub. Date: Apr. 16, 2026

(54) INTELLIGENT HARDWARE FOR PRODUCTION SAFETY DECISION-MAKING

(71) Applicant: Xiangfu Laboratory, Jiaxing (CN)

(72) Inventors: Haitao Song, Jiaxing (CN); Zikai Wang, Jiaxing (CN); Hao Shen, Jiaxing (CN); Yuechen Liu, Jiaxing (CN); Yuanyuan Lin, Jiaxing (CN); Jingzhe Qian, Jiaxing (CN); Yue Teng, Jiaxing (CN); Guan Huang, Jiaxing (CN); Yuting Yang, Jiaxing (CN); Zihan Feng, Jiaxing (CN); Yiran Xie, Jiaxing (CN); Chengxiang Li, Jiaxing (CN)

(21) Appl. No.: 18/978,541

(22) Filed: Dec. 12, 2024

(30) Foreign Application Priority Data
Oct. 11, 2024 (CN) 202411418505X

(51) Int. Cl. G06Q 10/0631; G06Q 50/04

(52) U.S. Cl. CPC G06Q 10/06312; G06Q 50/04

(57) ABSTRACT

An intelligent hardware for production safety decision-making comprises a data acquisition module for real-time acquisition of physical quantities in the production environment and production equipment; a data processing module, used to pre-process the collected physical quantity data and predict production bottlenecks; an intelligent analysis and decision-making module, used to analyze the failure risk of production equipment based on the collected physical quantity and production bottleneck data, and to perform scheduling process based on the production bottleneck data and failure risk analysis results; the fault risk analysis is divided into the subjective risk factor analysis and objective risk factor analysis, the subjective risk factor analysis in this invention uses intuitionistic fuzzy numbers to assign specific risk values, which can handle the uncertainty and fuzziness in the evaluation process, making the evaluation results closer to the actual situation.

### 1. TECHNICAL FIELD

The invention relates to the technical field of data processing, in particular to an intelligent hardware for production safety decision-making.

### 2. BACKGROUND ART

Intelligent manufacturing is the deep and comprehensive integration of traditional manufacturing industries with information technology and intelligent technologies, aiming to enhance the scientific and accurate decision-making in industrial production processes, as well as to improve the level and efficiency of automation control in the manufacturing process.

From the hardware perspective, intelligent manufacturing involves the integrating various types of sensors and imaging devices into every aspect of the production line, achieving comprehensive coverage and high real-time of information perception; it also includes the use of the industrial internet of wired and wireless media to enable uplink and downlink communication and transmission of information, data, and instructions, forming a sustainable flow of information. From the software perspective, intelligent manufacturing requires the establishment of a multi-source big data center and an intelligent decision-making hub; this allows for the construction, training, and validation of various decision-making models based on big data, enabling continuously optimized intelligent decisions; furthermore, based on these intelligent decisions, automatic control instructions are generated and issued to every segment of the production line.

The safety production risks at each stage of the production line are one of the key concerns of intelligent manufacturing; the safety production risks encompass various aspects of safety risks. Currently, in terms of production safety risks, intelligent manufacturing primarily monitors and alarms safety-related parameters based on sensors and the industrial internet, comprising the sensing, collection, and uploading of environmental parameters, status parameters, electrical variable parameters, and equipment status values at various stages, facilities, and spaces of the production line; subsequently, safety production risk assessments and decisions are made by using methods such as overrun judgment and log analysis; necessary measures, such as monitoring, alarming, and shutdowns, are then implemented with the goal of maintaining safety in production.

Currently, the major shortcomings of intelligent manufacturing technology in terms of safety production risks lie in the lack of an effective and reliable safety production risk decision-making system for the comprehensive multi-factorial models across various aspects of the production line, especially in certain production modes, the aforementioned multi-type comprehensive factors are also characterized by rapid and complex changes, leading to problems of high misjudgment rates and large time delays in safety production risk decisions, making it impossible to take truly effective measures.

Therefore, it is necessary to provide an intelligent hardware for production safety decision-making to solve the above technical problems.

### 3. SUMMARY OF THE INVENTION

In order to solve the technical problems of the lack of an effective and reliable safety production risk decision-making system for the comprehensive multi-factorial models across various aspects of the production line, especially in certain production modes, the aforementioned multi-type comprehensive factors are also characterized by rapid and complex changes, leading to problems of high misjudgment rates and large time delays in safety production risk decisions, making it impossible to take truly effective measures, the invention provides an intelligent hardware for production safety decision-making.

The intelligent hardware for production safety decision-making, comprising a data acquisition module for real-time acquisition of physical quantities in the production environment and production equipment;
a data processing module, used to pre-process the collected physical quantity data and predict production bottlenecks;
an intelligent analysis and decision-making module, used to analyze the failure risk of production equipment based on the collected physical quantity and production bottleneck data, and to perform scheduling process based on the production bottleneck data and failure risk analysis results;
the fault risk analysis is divided into the subjective risk factor analysis and objective risk factor analysis, the subjective risk factor analysis is based on the content of the maintenance manual of production equipment, assigning specific intuitionistic fuzzy numbers to each risk factor, and establishing an intuitionistic evaluation set for the corresponding subjective risk factors; the objective risk factor analysis involves obtaining a difference value from the fault intensity of abnormal physical quantities at time t within the collected time interval minus the minimum fault intensity within the entire time interval, this difference determines the fault intensity range, the difference value is then normalized based on the fault intensity range within the entire time interval, resulting in a relative value between 0 and 1; by combining subjective risk factor analysis and objective risk factor analysis, the dynamic changes of the production equipment in the time domain are obtained.

Further, the prediction of the production bottlenecks comprises obtaining an exponential sequence of production data within a certain period of time, applying an average weakening buffer operator to smooth the exponential sequence of production data, constructing a grey prediction model, and outputting the prediction results.

Further, the fault intensity range is a maximum value of the abnormal physical quantities minus a minimum value of the abnormal physical quantities.

Further, the physical quantities comprise temperature, pressure, gas concentration.

Further, the data acquisition module comprises a temperature sensor, a pressure sensor, and a gas sensor, each sensor converts the collected physical quantities into an electrical signal, and transmits the electrical signal to the data processing module.

Further, the pre-processing of the collected physical quantity data comprises filtering and denoising the collected physical quantities.

Further, the scheduling process comprises the following steps:
S1. selecting a production task with the highest delay rate;
S2. randomly choosing an incomplete workpiece;
S3. in the processing process, selecting a workpiece with the shortest processing time on the earliest available machine;
S4. prioritizing a production order with the shortest remaining processing time;
S5. updating the number of completed processes for a selected task;
S6. repeating S1 to S5 until all tasks are completed.

Further, the delay rate is calculated as follows:

$$D R = {T}_{c} + {\sum }_{j = o {p}_{i} ( t ) + 1}^{{n}_{i}} \overline{{t}_{ι , J}} - {D}_{i}$$

wherein nᵢ is the total number of processes for task i, opᵢ(t) is the number of processes currently completed for task i, t̅_̅{̅l̅,̅J̅}̅ is the average processing time of all available production equipment, Dᵢ is the expected completion time for task i, and T_{c} is the current time.

Further, the scheduling process further comprises the following steps:
S1. determining a optimal maintenance interval for a single production equipment under batch production;
S2. establishing a penalty function for the single production equipment;
S3. determining a short-term maintenance window;
S4. formulating a combined maintenance plan;
S5. dynamically updating the combined maintenance plan based on changes in maintenance information.

Compared with the prior art, the invention has the following advantageous effects:

1. in the invention, the subjective risk factor analysis takes into account the role of human experience and knowledge in risk assessment by referring to the content of the maintenance manual. This allows for the capture of risk factors that are difficult to quantify directly. This helps identify the impact of subjective aspects, such as human operation and management decisions, on equipment failures. The objective risk factor analysis is based on actual data and reflects the impact of the equipment's physical state and external environment on its performance by quantifying changes in fault intensity. Quantitative analysis provides more specific and objective risk information, this enables a more thorough understanding of the operating condition of production equipment, helping to identify and eliminate potential safety hazards and failure factors in a timely manner, thereby enhancing the reliability and stability of the equipment, reducing the likelihood of human intervention and operational errors.

2. The invention performs scheduling processing by understanding the dynamic changes of production equipment in the time domain. During the period when equipment failures are most likely to occur, maintenance and replacement plans can be arranged in advance to avoid production interruptions. During the period when equipment performance is stable, production load can be increased to improve production efficiency.

3. The subjective risk factor analysis in this invention uses intuitionistic fuzzy numbers to assign specific risk values, which can handle the uncertainty and fuzziness in the evaluation process, making the evaluation results closer to the actual situation; the objective risk factor analysis, on the other hand, standardizes the failure states at different time points to the same scale for comparison by calculating the relative value of the failure intensity, thereby more accurately reflecting the trend of changes in equipment failure intensity and improving the accuracy of risk assessment.

### 4. BRIEF DESCRIPTION OF ACCOMPANY DRAWINGS

FIG. 1 is a system block diagram of the intelligent hardware for production safety decision-making provided by the invention.

FIG. 2 is a flowchart 1 of the scheduling process provided by the invention.

FIG. 3 is a flowchart 2 of the scheduling process provided by the invention.

FIG. 4 is a flowchart of predicting production bottlenecks provided by the invention.

FIG. 5 is a flowchart of constructing a grey prediction model provided by the invention.

FIG. 6 is a flowchart of assigning the intuitionistic fuzzy numbers provided by the invention.

### 5. SPECIFIC EMBODIMENT OF THE INVENTION

The invention will be further described in detail in combination with the accompanying drawings and specific embodiments.

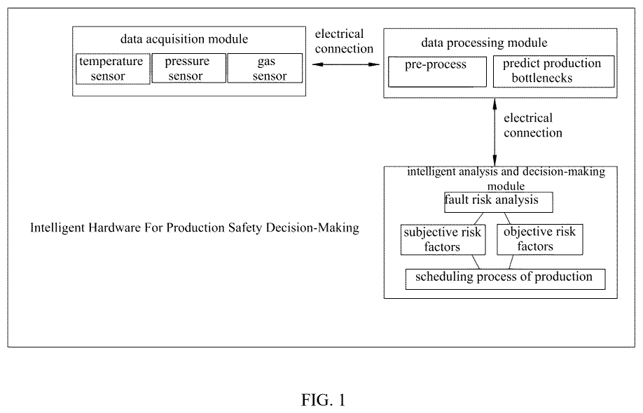

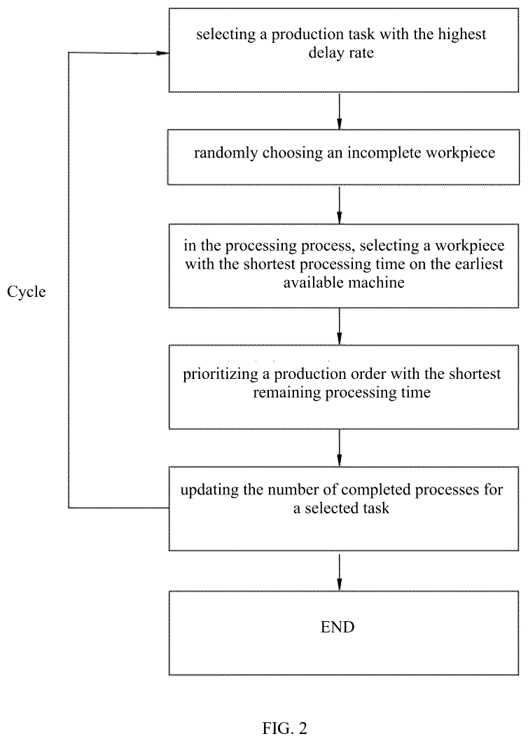

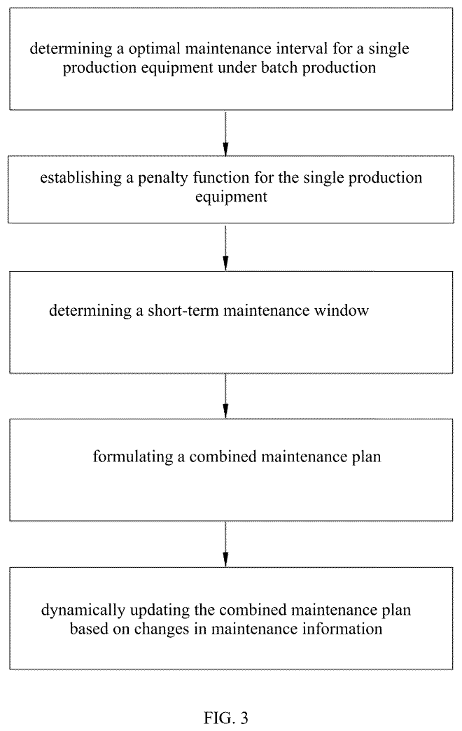

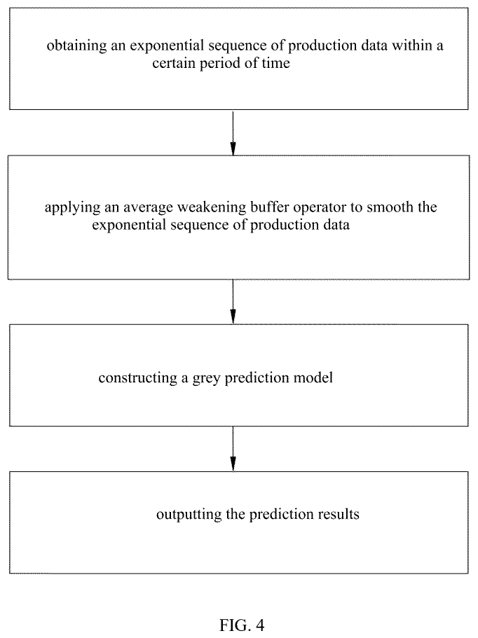

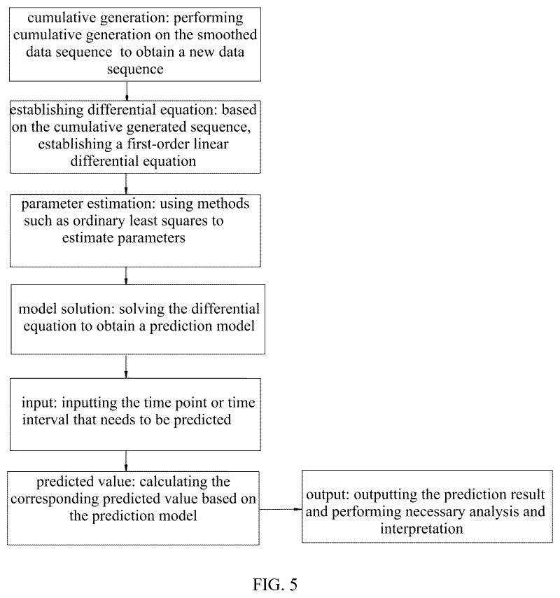

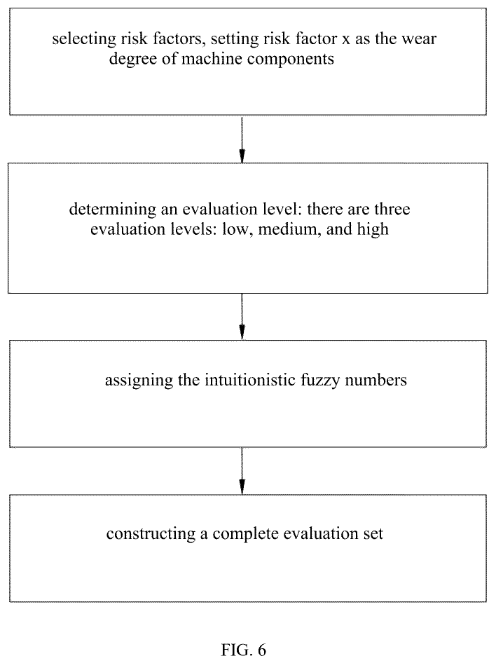

Please refer to FIGS. 1, 2, 3, 4, 5 and 6, wherein FIG. 1 is a system block diagram of the intelligent hardware for production safety decision-making provided by the invention; FIG. 2 is a flowchart 1 of the scheduling process provided by the invention; FIG. 3 is a flowchart 2 of the scheduling process provided by the invention; FIG. 4 is a flowchart of predicting production bottlenecks provided by the invention; FIG. 5 is a flowchart of constructing a grey prediction model provided by the invention; FIG. 6 is a flowchart of assigning the intuitionistic fuzzy numbers provided by the invention.

In the specific implementation process, as shown in FIG. 1- FIG. 6, the intelligent hardware for production safety decision-making, comprising a data acquisition module for real-time acquisition of physical quantities in the production environment and production equipment; the physical quantities comprise temperature, pressure, gas concentration; the data acquisition module comprises a temperature sensor, a pressure sensor, and a gas sensor, each sensor converts the collected physical quantities into an electrical signal, and transmits the electrical signal to the data processing module;
a data processing module, used to pre-process the collected physical quantity data and predict production bottlenecks;
an intelligent analysis and decision-making module, used to analyze the failure risk of production equipment based on the collected physical quantity and production bottleneck data, and to perform scheduling process based on the production bottleneck data and failure risk analysis results;
the fault risk analysis is divided into the subjective risk factor analysis and objective risk factor analysis, the subjective risk factor analysis is based on the content of the maintenance manual of production equipment, assigning specific intuitionistic fuzzy numbers to each risk factor x∈U, and establishing an intuitionistic evaluation set for the corresponding subjective risk factors; which is expressed as follows:

$$S = \{ x , ( [ {u}_{x}^{l} , {u}_{x}^{u} ] , [ {v}_{x}^{l} , {v}_{x}^{u} ] , [ {w}_{x}^{l} , {w}_{x}^{u} ] ) \vert x ∈ U \}$$

Wherein

$${u}_{x}^{l} and {u}_{x}^{u}$$

are upper and lower limits of membership degree in the evaluation set, respectively, which signify minimum and maximum likelihoods that element x belongs to a certain evaluation grade;

$${v}_{x}^{l} and {v}_{x}^{u}$$

are upper and lower limits of non-membership degree in the evaluation set, respectively, which signify minimum and maximum probabilities that element x does not belong to a certain evaluation grade;

$${w}_{x}^{l} and {w}_{x}^{u}$$

are upper and lower limits of hesitancy degree in the evaluation set, respectively, which signify minimum and maximum ranges of uncertainty for the evaluator when judging that element x belongs to a certain evaluation grade.

Referring to FIG. 6, the assigning process of the intuitionistic fuzzy numbers is as follows:
1. selecting risk factors, setting risk factor x as the wear degree of machine components;
2. determining an evaluation level: there are three evaluation levels: low, medium, and high;
3. assigning the intuitionistic fuzzy numbers: for the evaluation grade of “low,” there is a high probability that the wear degree of machine components is low, but there is a certain degree of uncertainty; the membership degree interval can be set as [0.7, 0.9] (indicating a likelihood of at least 70% to 90% that it is low), and the non-membership degree interval as [0.05, 0.2] (indicating a possibility of at most 5% to 20% that it is not low); the hesitancy degree interval is calculated as [0.1−(0.05+0.2), 0.3−(0.7+0.2)]=[0.05, 0.1](it should be noted that the normalized condition ux+vx+wx=1 is used herein to calculate the hesitancy degree interval). Similar approaches can be applied to the evaluation grades of “medium” and “high.”
4. constructing a complete evaluation set:
S={“Wear degree of machine components,” ([0.7,0.9],[0.05,0.2],[0.05,0.1]) for “Low,” . . . (assign similar intuitionistic fuzzy numbers for “Medium” and “High” evaluation levels)};
the objective risk factor analysis involves obtaining a difference value from the fault intensity of abnormal physical quantities at time t within the collected time interval minus the minimum fault intensity within the entire time interval, this difference determines the fault intensity range, the difference value is then normalized based on the fault intensity range within the entire time interval, resulting in a relative value between 0 and 1; the subjective risk factor analysis in this invention uses intuitionistic fuzzy numbers to assign specific risk values, which can handle the uncertainty and fuzziness in the evaluation process, making the evaluation results closer to the actual situation; the objective risk factor analysis, on the other hand, standardizes the failure states at different time points to the same scale for comparison by calculating the relative value of the failure intensity, thereby more accurately reflecting the trend of changes in equipment failure intensity and improving the accuracy of risk assessment;
it should be noted that the fault intensity range is a maximum value of the abnormal physical quantities minus a minimum value of the abnormal physical quantities:
setting the maximum and minimum fault intensities within the time interval [t_{b}, tₑ] for collecting physical quantities as wₘₐₓ(t_{b}, tₑ) and wₘᵢₙ(t_{b}, tₑ), respectively; then the relative fault intensity of the abnormal physical quantity FMⱼ at t time within the interval t∈[t_{b}, tₑ] is as follows:

$$P ( t \vert F {M}_{j} , E P ) = \frac{w ( t \vert F {M}_{j} , EP ) - {w}_{min} ( {t}_{b} , {t}_{e} )}{{w}_{max} ( {t}_{b} , {t}_{e} ) - {w}_{min} ( {t}_{b} , {t}_{e} )}$$

It should be noted that t_{b} and tₑ represent the start and end time of the time interval respectively;
w(t|FMⱼ, EP) represents the fault intensity of a given abnormal physical quantity FMⱼ at t time, under certain environmental or operating conditions EP;
wₘₐₓ(t_{b}, tₑ) and wₘᵢₙ(t_{b}, tₑ) respectively represent the maximum and minimum fault intensities of all abnormal physical quantities within the time interval [t_{b}, tₑ];
by combining subjective risk factor analysis and objective risk factor analysis, the dynamic changes of the production equipment in the time domain are obtained; by comprehensively analyzing both subjective and objective risk factors, risk factor analysis is an ongoing process that requires continuous collection and analysis of new data and information; this enables a more thorough understanding of the operating condition of production equipment, helping to identify and eliminate potential safety hazards and failure factors in a timely manner, thereby enhancing the reliability and stability of the equipment, reducing the likelihood of human intervention and operational errors.

Further, referring to FIG. 4, the prediction of the production bottlenecks comprises obtaining an exponential sequence θ=(θ₁, θ₂, . . . , θ_{g}, . . . , θₙ) of production data within a certain period of time, applying an average weakening buffer operator to smooth the exponential sequence of production data, constructing a grey prediction model, and outputting the prediction results:
applying the average weakening buffer operator to smooth the exponential sequence of production data:

$$\begin{matrix}X = θ D = ( {θ}_{1} d , {θ}_{2} d , … , {θ}_{g} d , … , {θ}_{n} d ) \\ {x}_{g} = {θ}_{g} d = \frac{[ {θ}_{g} + {θ}_{( g + 1 )} + … + {θ}_{n} ]}{n - g + 1} \\ g = 3 , 4 … , n - 1\end{matrix}$$

For the first two elements of the sequence (i.e., g=1,2), this smoothing process is usually not applied because they do not have enough subsequent elements to calculate the average.

Referring to FIG. 5, constructing the grey prediction model comprises:
1. cumulative generation: performing cumulative generation on the smoothed data sequence X to obtain a new data sequence X₁;
2. establishing differential equation: based on the cumulative generated sequence X₁, establishing a first-order linear differential equation

$$\frac{d {x}_{1}}{dt} + a {x}_{1} = b ;$$

3. parameter estimation: using methods such as ordinary least squares to estimate parameters a and b;
4. model solution: solving the differential equation to obtain a prediction model;
5. input: inputting the time point or time interval that needs to be predicted;
6. predicted value: calculating the corresponding predicted value based on the prediction model.
7. output: outputting the prediction result and performing necessary analysis and interpretation.

Furthermore, the pre-processing of the collected physical quantity data comprises filtering and denoising the collected physical quantities.

In a specific embodiment, referring to FIG. 2, the scheduling process comprises the following steps:
S1. selecting a production task with the highest delay rate;
S2. randomly choosing an incomplete workpiece;
S3. in the processing process, selecting a workpiece with the shortest processing time on the earliest available machine;
S4. prioritizing a production order with the shortest remaining processing time;
S5. updating the number of completed processes for a selected task;
S6. repeating S1 to S5 until all tasks are completed.

Further, the delay rate is calculated as follows:

$$D R = {T}_{c} + {\sum }_{j = o {p}_{i} ( t ) + 1}^{{n}_{i}} \overline{{t}_{ι , J}} - {D}_{i}$$

wherein nᵢ is the total number of processes for task i, opᵢ(t) is the number of processes currently completed for task i, t̅_̅{̅l̅,̅J̅}̅ is the average processing time of all available production equipment, Dᵢ is the expected completion time for task i, and T_{c} is the current time;
specific calculation steps:
1. determining the current time: firstly, determining the current time T_{c};
2. determining the current status of task i: identifying the number of processes currently completed for task i at the current time T_{c};
3. calculating the sum of the average processing time for the remaining processes: for each remaining process (from the opᵢ(t)+1 to nᵢ), calculating its average processing time, summing these average processing times to obtain the total processing time

$${\sum }_{j = {op}_{i} ( t ) + 1}^{{n}_{i}} \overline{{t}_{ι , J}}$$

for the remaining processes;
4. calculating delay: subtracting the expected completion time Dᵢ for task i from the total processing time of the remaining processes (if Dᵢ is less than or equal to the total processing time of the remaining processes, the result will be positive, indicating a delay; if it is negative, it may suggest that the expected time is set too long or there is an error in calculation). It should be noted that the formula herein does not directly subtract Dᵢ, but rather calculates the sum of the average processing time of the remaining processes, because the delay rate is calculated by comparing some kind of difference between the actual completion time and the expected completion time. In practical applications, further processing of this sum is required to obtain the delay rate (for example, by comparing it with Dᵢ or a benchmark time).

Referring to FIG. 3, the scheduling process further comprises the following steps:
S1. determining a optimal maintenance interval for a single production equipment under batch production;
S2. establishing a penalty function for the single production equipment;
S3. determining a short-term maintenance window;
S4. formulating a combined maintenance plan;
S5. dynamically updating the combined maintenance plan based on changes in maintenance information

### Experiment 1

To verify the effectiveness of the invention in scheduling process, six production devices were randomly selected, designated as A1, A2, A3, A4, A5, and A6. The fault locations, repair effectiveness, and post-repair damage of these six production devices were detected. The test results are as follows:

| Sequence of | | | | |
|---|---|---|---|---|
| Production | | | | |
| Bottleneck | Fault | Repair | Whether | Post-repair |
| Machines | Locations | Effectiveness | Adjusted | Damage |
| A1 | Feed system | Perfect repair | Yes | No |
| A2 | Feed system | Perfect repair | Yes | Yes |
| A3 | Hydraulic | insufficient repair | Yes | Yes |
| | system | | | |
| A4 | Feed system | Perfect repair | Yes | No |
| A5 | Hydraulic | Perfect repair | Yes | No |
| | system | | | |
| A6 | Feed system | Perfect repair | Yes | No |

As shown in the table above, the invention greatly improves the repair efficiency by formulating a combination repair plan, determining short-term maintenance windows, ensuring that each component undergoes at least one maintenance, and allowing multiple maintenance activities for each component.

From the description of the above embodiments, those skilled in the art can clearly understand that the various embodiments can be implemented using software and a general hardware platform, and of course, can also be implemented through hardware. Based on this understanding, the technical scheme described above, or the parts that contribute to the related technologies, can be embodied in the form of a software product. This computer software product can be stored in a computer-readable storage medium, such as ROM/RAM, disks, CD, etc., and includes several instructions that cause a computing device (which may be a personal computer, server, or network device) to perform the methods described in the various embodiments or parts of the embodiments.

The above shows and describes the basic principles and main features of the invention and the advantages of the invention. For those skilled in the art, it is obvious that the invention is not limited to the details of the above exemplary embodiments, and the invention can be implemented in other specific forms without departing from the spirit or basic features of the invention. Therefore, no matter from which point of view, the embodiments should be regarded as exemplary and non-restrictive. The scope of the invention is defined by the attached claims rather than the above description. Therefore, it is intended to include all changes within the meaning and scope of the equivalent elements of the claims. Any figure mark in the claims should not be regarded as limiting the claims involved.

In addition, it should be understood that although this specification is described in accordance with embodiments, not every embodiment includes only one independent technical solution. This description of the specification is only for the sake of clarity. Those skilled in the art should regard the specification as a whole. The technical solutions in each embodiment can also be appropriately combined to form other embodiments that can be understood by those skilled in the art.

1. An intelligent hardware for production safety decision-making, comprising a data acquisition module for real-time acquisition of physical quantities in the production environment and production equipment;
a data processing module, used to pre-process the collected physical quantity data and predict production bottlenecks;
an intelligent analysis and decision-making module, used to analyze the failure risk of production equipment based on the collected physical quantity and production bottleneck data, and to perform scheduling process based on the production bottleneck data and failure risk analysis results;
the fault risk analysis is divided into the subjective risk factor analysis and objective risk factor analysis, the subjective risk factor analysis is based on the content of the maintenance manual of production equipment, assigning specific intuitionistic fuzzy numbers to each risk factor, and establishing an intuitionistic evaluation set for the corresponding subjective risk factors; the objective risk factor analysis involves obtaining a difference value from the fault intensity of abnormal physical quantities at time t within the collected time interval minus the minimum fault intensity within the entire time interval, this difference determines the fault intensity range, the difference value is then normalized based on the fault intensity range within the entire time interval, resulting in a relative value between 0 and 1; by combining subjective risk factor analysis and objective risk factor analysis, the dynamic changes of the production equipment in the time domain are obtained.

2. The intelligent hardware for production safety decision-making of claim 1, wherein the prediction of the production bottlenecks comprises obtaining an exponential sequence of production data within a certain period of time, applying an average weakening buffer operator to smooth the exponential sequence of production data, constructing a grey prediction model, and outputting the prediction results.

3. The intelligent hardware for production safety decision-making of claim 1, wherein the fault intensity range is a maximum value of the abnormal physical quantities minus a minimum value of the abnormal physical quantities.

4. The intelligent hardware for production safety decision-making of claim 1, wherein the physical quantities comprise temperature, pressure, gas concentration.

5. The intelligent hardware for production safety decision-making of claim 1, wherein the data acquisition module comprises a temperature sensor, a pressure sensor, and a gas sensor, each sensor converts the collected physical quantities into an electrical signal, and transmits the electrical signal to the data processing module.

6. The intelligent hardware for production safety decision-making of claim 1, wherein the pre-processing of the collected physical quantity data comprises filtering and denoising the collected physical quantities.

7. The intelligent hardware for production safety decision-making of claim 1, wherein the scheduling process comprises the following steps:
S1. selecting a production task with the highest delay rate;
S2. randomly choosing an incomplete workpiece;
S3. in the processing process, selecting a workpiece with the shortest processing time on the earliest available machine;
S4. prioritizing a production order with the shortest remaining processing time;
S5. updating the number of completed processes for a selected task;
S6. repeating S1 to S5 until all tasks are completed.

8. The intelligent hardware for production safety decision-making of claim 7, wherein the delay rate is calculated as follows:
$$DR = {T}_{c} + {\sum }_{j = o {p}_{i} ( t ) + 1}^{{n}_{i}} \overline{{t}_{ι , J}} - {D}_{i}$$
wherein nᵢ is the total number of processes for task i, opᵢ(t) is the number of processes currently completed for task i, t̅_̅{̅l̅,̅J̅}̅ is the average processing time of all available production equipment, Dᵢ is the expected completion time for task i, and T_{c} is the current time.

9. The intelligent hardware for production safety decision-making of claim 8, wherein the scheduling process further comprises the following steps:
S1. determining an optimal maintenance interval for a single production equipment under batch production;
S2. establishing a penalty function for the single production equipment;
S3. determining a short-term maintenance window;
S4. formulating a combined maintenance plan;
S5. dynamically updating the combined maintenance plan based on changes in maintenance information.
